(19) United States
(12) Patent Application Publication
(10) Pub. No.: US 2015/0370524 A1
(43) Pub. Date: Dec. 24, 2015

(54) CONTENT PROVIDING DEVICE, CONTENT PROVIDING METHOD, AND COMPUTER PROGRAM PRODUCT

(71) Applicant: Kabushiki Kaisha Toshiba, Minato-ku (JP)

(72) Inventors: Mika MINEMATSU, Fuchu (JP); Hiroyuki AIZU, Yokohama (JP)

(73) Assignee: Kabushiki Kaisha Toshiba, Minato-ku (JP)

(21) Appl. No.: 14/715,986

(22) Filed: May 19, 2015

(30) Foreign Application Priority Data
Jun. 23, 2014 (JP) 2014-128457

(51) Int. Cl. G06F 3/14; H04N 5/06; H04N 5/14; G06F 3/147

(52) U.S. Cl. CPC G06F 3/1431; G06F 3/1446; G06F 3/147; H04N 5/06; H04N 5/147

(57) ABSTRACT

According to an embodiment, a content providing device includes a detector, a determination processor, a generator, and a communicating unit. The detector is configured to detect update objects included in a content to be displayed across a plurality of display devices. The update objects are dynamically updated. The determination processor is configured to determine update order in which the update objects are updated. The generator is configured to generate update order information when there is a change in the update order. The update order information includes the update order and information indicating the update objects. The communicating unit is configured to deliver the content to the display devices, and deliver the update order information to the display devices when there is a change in the update order.

### CROSS-REFERENCE TO RELATED APPLICATION

This application is based upon and claims the benefit of priority from Japanese Patent Application No. 2014-128457, filed on Jun. 23, 2014; the entire contents of which are incorporated herein by reference.

### FIELD

Embodiments described herein relate generally to a content providing device, a content providing method, and a computer program product.

### BACKGROUND

There is known a technique for displaying one image by a plurality of display devices cooperating with each other. To display one image by a plurality of display devices, synchronization of image display timing needs to be achieved between the plurality of display devices. In order to achieve synchronization of image display timing between the plurality of display devices, for example, display control using a synchronizing signal is performed.

However, the conventional art has difficulty in resolving the out-of-sync of display timing between a plurality of display devices without placing a processing load for achieving display synchronization, on the plurality of display devices.

### BRIEF DESCRIPTION OF THE DRAWINGS

FIG. 1 is a diagram illustrating an example of a configuration of a content providing system of a first embodiment;

FIG. 2 is a diagram illustrating an example of web content displayed by display devices of the first embodiment;

FIG. 3 is a diagram illustrating an example of the case in which the web content of FIG. 2 has been updated;

FIG. 4 is a diagram illustrating an example of content converted by a converter of the first embodiment;

FIG. 5 is a flowchart illustrating an example of an operating method of a content providing device of the first embodiment;

FIG. 6 is a flowchart illustrating an example of an operating method of the display device of the first embodiment;

FIG. 7 is a diagram illustrating an example of a configuration of a content providing system of a second embodiment;

FIG. 8 is a diagram illustrating an example of web content displayed by display devices of the second embodiment;

FIG. 9 is a diagram illustrating an example of the case in which the web content of FIG. 8 has been updated;

FIG. 10 is a diagram illustrating an example of a configuration of a content providing system of a third embodiment;

FIG. 11 is a diagram illustrating an example of image information which is delivered by a content providing device of the third embodiment;

FIG. 12 is a diagram illustrating an example of update image information which is delivered by the content providing device of the third embodiment;

FIG. 13 is a flowchart illustrating an example of an operating method of the content providing device of the third embodiment;

FIG. 14 is a flowchart illustrating an example of an operating method of a display device of the third embodiment;

FIG. 15 is a diagram illustrating an example of a configuration of a content providing system of a fourth embodiment;

FIG. 16 is a diagram illustrating an example of additional information which is added to web content, of the fourth embodiment;

FIG. 17 is a diagram illustrating an example of web content whose amount has been reduced by a content reducer of the fourth embodiment;

FIG. 18 is a flowchart illustrating an example of an operating method of a content providing device of the fourth embodiment;

FIG. 19 is a flowchart illustrating an example of an operating method of a display device of the fourth embodiment; and

FIG. 20 is a diagram illustrating an example of a hardware configuration of the content providing devices of the first to fourth embodiments.

### DETAILED DESCRIPTION

According to an embodiment, a content providing device includes a detector, a determination processor, a generator, and a communicating unit. The detector is configured to detect update objects included in a content to be displayed across a plurality of display devices. The update objects are dynamically updated. The determination processor is configured to determine update order in which the update objects are updated. The generator is configured to generate update order information when there is a change in the update order. The update order information includes the update order and information indicating the update objects. The communicating unit is configured to deliver the content to the display devices, and deliver the update order information to the display devices when there is a change in the update order.

Content providing devices, content providing methods, and programs of embodiments will be described below with reference to the accompanying drawings.

### First Embodiment

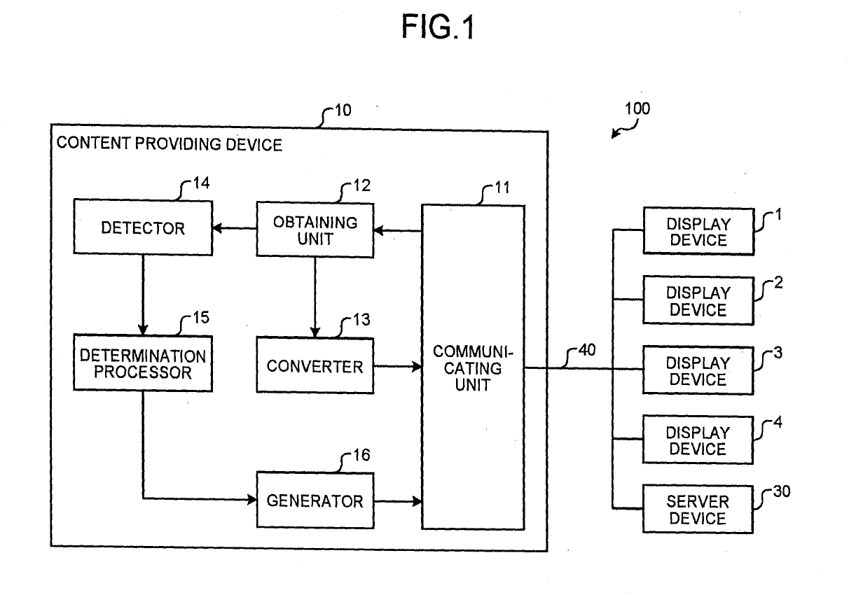

FIG. 1 is a diagram illustrating an example of a configuration of a content providing system 100 of a first embodiment. The content providing system 100 of the first embodiment includes a display device 1, a display device 2, a display device 3, a display device 4, a content providing device 10, and a server device 30. Note that the number of display devices is not limited to four and may be any. The display device 1, the display device 2, the display device 3, the display device 4, the content providing device 10, and the server device 30 are connected to each other through a network 40. The network 40 is, for example, a WAN (Wide Area Network). Note that the communication scheme of the network 40 may be a wired or wireless one. Alternatively, the communication scheme of the network 40 may be implemented by combining a wired one and a wireless one.

The content providing device 10 and the server device 30 are any information processing device. The content providing device 10 delivers content to each of the display devices 1 to 4. In the description of the first embodiment, the content is hereinafter described as web content. The server device 30 stores web content which is delivered by the content providing device 10 to each of the display devices 1 to 4. Note that instead of the content providing device 10 and the server device 30 being different devices, the content providing device 10 and the server device 30 may be the same device. The display devices 1 to 4 display web content delivered from the content providing device 10. The display devices 1 to 4 are, for example, information processing devices including a liquid crystal display.

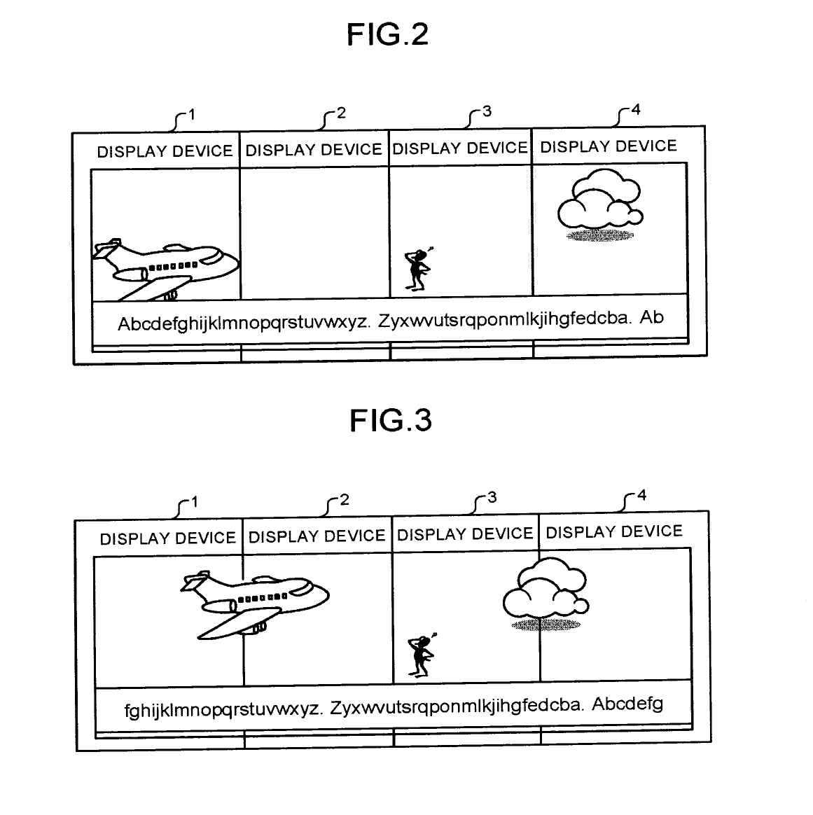

FIG. 2 is a diagram illustrating an example of web content displayed by the display devices 1 to 4 of the first embodiment. The example of FIG. 2 illustrates an example of web content including four HTML elements, i.e., a telop, an airplane, a cloud, and a person, as update objects. When the web content is updated, the telop and the cloud move from the right to the left, and the airplane moves from the lower left to the upper right. Note that the position of the person does not move. Hence, since the display of the person is not updated, the person is technically not an update object. However, the description of FIGS. 2 and 3 which will be described later is made such that, as an example of the lowest priority in display order upon updating display, the person is included in the update objects. In addition, the frequency of update to the update objects is high in order of the telop, the airplane, the cloud, and the person. In addition, the areas of the update objects are large in order of the telop, the airplane, the cloud, and the person. Note that the areas of the airplane and the cloud are substantially the same. In the example of FIG. 2, the telop is displayed across the display devices 1 to 4. Hence, when display synchronization between the display devices 1 to 4 is not achieved, the out-of-sync of the display of the telop is most noticeable. Note that, since the airplane, the cloud, and the person are not displayed by a plurality of display devices, even if the display is delayed, the out-of-sync of the display is not noticeable.

FIG. 3 is a diagram illustrating an example of the case in which the web content of FIG. 2 has been updated. The example of FIG. 3 is an example of the case in which telop text is scrolled from the right to the left, the airplane moves from the lower left to the upper right, and the cloud moves to the left. By the web content having been updated, the order in which the out-of-sync of display is noticeable changes to the order of the telop, the airplane, the cloud, and the person. The telop extends across the display devices 1 to 4 and has a high frequency of update and the largest area. Hence, when the timings of telop display by the display devices 1 to 4 go out of sync, its out-of-sync of display is most noticeable. Then, the airplane extends across the display devices 1 and 2 and has a high frequency of update, and thus, its out-of-sync of display is the second most noticeable. Then, the cloud extends across the display devices 3 and 4 and has a low frequency of update, and thus, its out-of-sync of display is the third most noticeable. Finally, the person is displayed only on the display device 3 and is not updated, and thus, there is no out-of-sync of display.

Referring back to FIG. 1, next, a detail of a configuration of the content providing device 10 will be described. The content providing device 10 of the first embodiment includes a communicating unit 11, an obtaining unit 12, a converter 13, a detector 14, a determination processor 15, and a generator 16.

The communicating unit 11 communicates with the display devices 1 to 4 and the server device 30. The communicating unit 11 receives, for example, a URL (Uniform Resource Locator) indicating the location of web content, from the display devices 1 to 4. Note that the communicating unit 11 may receive a URL from any one of the display devices 1 to 4. The communicating unit 11 inputs the URL to the obtaining unit 12.

In addition, the communicating unit 11 delivers pieces of web content which are converted for the respective display devices by the converter 13 which will be described later, to the corresponding display devices 1 to 4. In addition, the communicating unit 11 delivers update order information generated by the generator 16 which will be described later, to each of the display devices 1 to 4.

When the obtaining unit 12 accepts the URL from the communicating unit 11, the obtaining unit 12 obtains web content indicated by the URL from the server device 30. The obtaining unit 12 inputs the web content to the converter 13 and the detector 14.

When the converter 13 accepts the web content from the communicating unit 11, the converter 13 converts the web content so that display of the web content according to the display positions of the respective display devices can be performed.

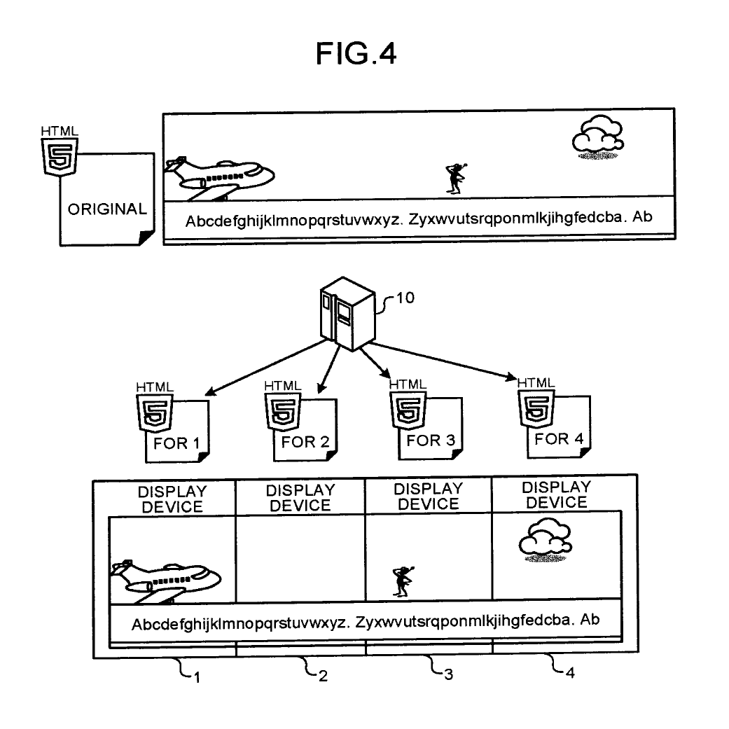

FIG. 4 is a diagram illustrating an example of content converted by the converter 13 of the first embodiment. Specifically, first, the converter 13 converts original web content obtained by the obtaining unit 12 from the server device 30, such that the web content is displayed according to the display regions of the respective display devices 1 to 4. Then, the communicating unit 11 delivers the pieces of converted web content to the corresponding display devices 1 to 4.

A method of converting web content so that display of the web content according to the display positions of the respective display devices can be performed may be any. The web content may be divided, or the display regions of the web content may be specified without dividing the web content.

When the display regions of the web content are specified, the converter 13 performs, for example, conversion such that the X coordinates (coordinates in a horizontal direction) on the upper left of the screens of the display device 1, the display device 2, the display device 3, and the display device 4 are at the positions of 0%, 25%, 50%, and 75% in the width of the web content, respectively. Specifically, the converter 13 specifies, for each display device, the arrangement position of the <body> element, using the CSS (Cascading Style Sheets) 3 position property, left property, etc. Alternatively, the converter 13 may move, for each display device, the display position of the <body> element, using translate API of the CSS3 transform property. Alternatively, the converter 13 may specify, for each display device, a scroll position, using the JavaScript (registered trademark) scroll API. Note that the CSS is used to specify how HTML elements are displayed.

Referring back to FIG. 1, the converter 13 also converts the web content so that a change to the display of the web content according to update order information which will be described later can be made. The converter 13 converts web content by, for example, adding a JavaScript (registered trademark) program to the web content. The JavaScript (registered trademark) program establishes a WebSocket connection between the display devices 1 to 4 and the content providing device 10. When update order information is received by the WebSocket connection, display is updated according to the update order information.

The converter 13 delivers the pieces of converted web content to the corresponding display devices 1 to 4 through the communicating unit 11.

The detector 14 analyzes the web content and thereby detects update objects which are dynamically updated, from the web content. In the above-described examples of FIGS. 2 and 3, the telop, the airplane, and the cloud are detected as update objects. Examples of HTML elements of web content which are detected as update objects include animation and text scroll (telop). The animation is JavaScript (registered trademark) animation, GIF animation, CSS animation, SVG animation, or the like. The text scroll is the CSS3 marquee properties, etc.

A method of analyzing web content by the detector 14 may be any. The detector 14 may monitor changes in coordinates indicating the display positions of HTML elements, by performing, for example, a process equivalent to a web browser rendering process. Namely, when the coordinates change, the detector 14 detects the HTML elements as update objects which are dynamically updated. Alternatively, the detector 14 may analyze web content as source code and detect HTML elements as update objects which are dynamically updated, based on tag information, etc.

The detector 14 inputs information indicating update objects and information required to determine the update order of the update objects, to the determination processor 15. The information required to determine the update order of the update objects is, for example, web content and the history information of coordinates indicating the display positions of the update objects. The history information is, for example, information in which time elapsed from the start of display is associated with the coordinates of an update object obtained during the time.

Not that, when the display of the web content has been updated by the passage of time (see FIG. 3), the detector 14 inputs again information indicating update objects and information required to determine the update order of the update objects, to the determination processor 15.

When the determination processor 15 accepts from the detector 14 the information indicating update objects and the information required to determine the update order of the update objects, the determination processor 15 determines update order in which the update objects are updated. The determination processor 15 determines the update order of the update objects based on, for example, at least one of conditions including coordinates indicating the display positions of the update objects, the frequency of update to the update objects, the areas of the update objects, and the moving speeds of the update objects.

Specifically, the determination processor 15 determines, from coordinates indicating the display position of an update object, whether the update object is displayed across two or more display devices. The determination processor 15 gives priority to the update order of an update object displayed across a plurality of display devices, over the update order of an update object not displayed across a plurality of display devices.

In addition, the determination processor 15 determines the frequency of update to the update objects by, for example, variable values in an animation program. The determination processor 15 gives priority to the update order of an update object with a high frequency of update over the update order of an update object with a low frequency of update.

In addition, the determination processor 15 determines the areas of the update objects by the size information of HTML elements. The determination processor 15 gives priority to the update order of an update object with a large area over the update order of an update object with a small area.

In addition, the determination processor 15 determines the moving speeds of the update objects by the speeds of change in coordinates indicating the positions of HTML elements which are obtained by the rendering process (history information of the coordinates). The determination processor 15 gives priority to the update order of an update object with a high moving speed over the update order of an update object with a low moving speed.

Note that it may be determined as appropriate which one among the coordinates indicating the display positions of the update objects, the frequency of update to the update objects, the areas of the update objects, and the moving speeds of the update objects is given priority to determine the update order.

When there is a change in the update order due to an update to the display of the web content by the passage of time, the determination processor 15 inputs information indicating update objects and the update order of the update objects to the generator 16.

Now, a specific example of update order will be described. For example, in the example of FIG. 3, update order is determined in the order in which the out-of-sync of display described in FIG. 3 is noticeable. Specifically, the update order is the order of the telop, the airplane, and the cloud. Note that the display of the person is not updated. Hence, whether to include the person in the determination of update order may be determined as appropriate according to, for example, how to display web content on the display devices 1 to 4.

Referring back to FIG. 1, the generator 16 accepts the information indicating update objects and the update order of the update objects, from the determination processor 15. Then, the generator 16 generates update order information including the information indicating update objects and the update order of the update objects, and delivers the update order information to each of the display devices 1 to 4 through the communicating unit 11.

Note that the generator 16 delivers update order information to each of the display devices 1 to 4 through the communicating unit 11 at timing at which the state of the web content displayed by the display devices 1 to 4 matches the state of the display of the web content obtained when the update order information is determined by the determination processor 15. Then, when the display devices 1 to 4 receive the update order information, the display devices 1 to 4 update the update objects according to the update order information. Note that the timing at which the state of the web content displayed by the display devices 1 to 4 matches the state of the display of the web content obtained when the update order information is determined by the determination processor 15 can be calculated from a time at which the display devices 1 to 4 start the display of the web content (a time at which the web content converted by the converter 13 is delivered).

Alternatively, the generator 16 may include, in update order information, an application time at which the update order information is applied, and transmit the update order information beforehand to the display devices 1 to 4. Note that the application time is, for example, a time elapsed from the start of display of web content, and is determined by the detector 14 or the determination processor 15. In this case, when the state of the web content displayed by the display devices 1 to 4 matches the state of the display of the web content obtained when update order information is determined by the determination processor 15, i.e., when the time has reached the application time, the display devices 1 to 4 update the update objects according to the update order information.

Alternatively, the generator 16 may divide update order information into a plurality of update messages for each update object and deliver the update messages to the display devices 1 to 4 according to the update order of the update objects. Namely, the update order may be represented by the order in which the update messages are transmitted.

In addition, the generator 16 may include, in update order information, information (a program, etc.) indicating a method of updating the update objects. Basically, by the browsers of the display devices 1 to 4 executing web content, the positions of update objects included in the web content change. However, by further including information indicating a method of updating the update objects in update order information, the display devices 1 to 4 can move the positions of the update objects according to the update order information.

Next, a content providing method for the content providing system 100 of the first embodiment will be described. First, an example of an operating method of the content providing device 10 will be described.

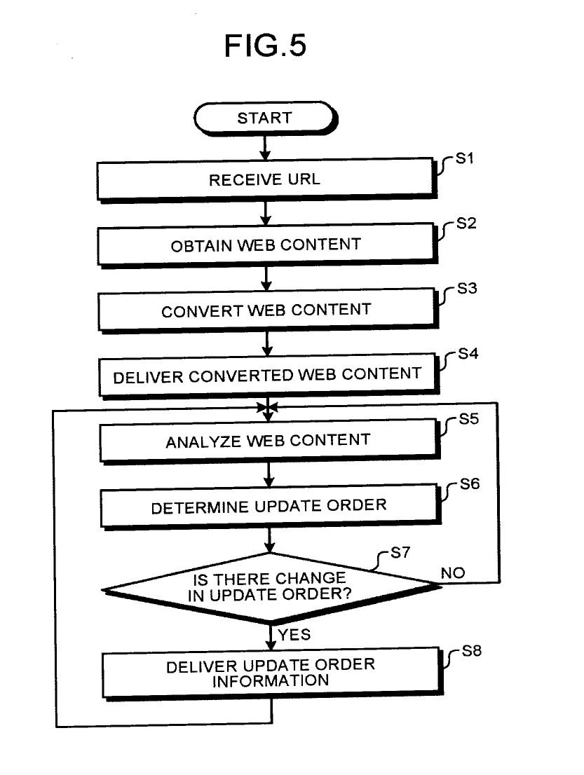

FIG. 5 is a flowchart illustrating an example of an operating method of the content providing device 10 of the first embodiment. First, the communicating unit 11 receives a URL indicating the location of web content, from the display devices 1 to 4 (step S1). Then, the obtaining unit 12 obtains web content indicated by the URL received at step S1, from the server device 30 (step S2).

Then, the converter 13 converts the web content so that display of the content according to the display positions of the respective display devices 1 to 4 and a change to the display of the web content according to the above-described update order information can be performed (step S3). Then, the communicating unit 11 delivers the web content converted at step S3 to each of the display devices 1 to 4 (step S4).

Then, the detector 14 analyzes the web content by the above-described method and thereby detects update objects which are dynamically updated, from the web content (step S5). Then, the determination processor 15 determines the update order of the update objects, based on at least one of conditions including coordinates indicating the display positions of the update objects, the frequency of update to the update objects, the areas of the update objects, and the moving speeds of the update objects (step S6).

Then, the determination processor 15 determines whether there is a change in the update order (step S7). If there is a change in the update order (Yes at step S7), the generator 16 generates update order information including information indicating update objects and the update order of the update objects, and delivers the update order information to each of the display devices 1 to 4 through the communicating unit 11 (step S8). Then, the process of the content providing device 10 returns to step S5. If there is no change in the update order (No at step S7), the process of the content providing device 10 returns to step S5.

Next, an example of an operating method of the display devices 1 to 4 will be described. Since the display devices 1 to 4 have the same operating method, the case of the display device 1 will be described as an example.

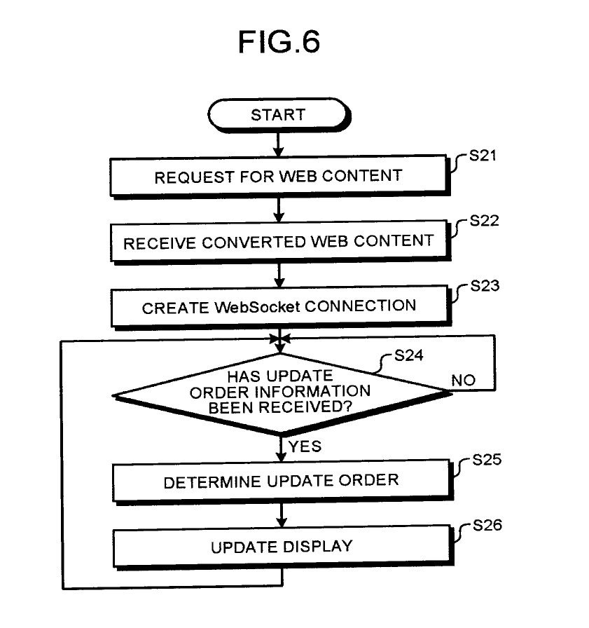

FIG. 6 is a flowchart illustrating an example of an operating method of the display device 1 of the first embodiment. The display device 1 requests the content providing device 10 for web content by transmitting a URL to the content providing device 10 (step S21). The display device 1 transmits a URL to the content providing device 10 by, for example, registering the content providing device 10 as a proxy server which is used when accessing the network 40 by a browser. Specifically, when the browser of the display device 1 requests for web content on the network 40, an HTTP request including a URL of the web content is transmitted from the display device 1 to the content providing device 10.

Then, the display device 1 receives web content converted by the above-described method by the converter 13 of the content providing device 10 (step S22). Then, the display device 1 executes the converted web content by the browser and thereby creates a WebSocket connection for the content providing device to receive the above-described update order information (step S23).

Then, the display device 1 determines whether update order information has been received (step S24). If update order information has not been received (No at step S24), the display device 1 waits until receiving update order information. If update order information has been received (Yes at step S24), the display device 1 determines (changes) the update order of update objects according to the update order information (step S25). Then, the display device 1 updates the update objects using the update order determined at step S25 and thereby updates the display of the web content (step S26). Then, the process of the display device 1 returns to step S24.

As described above, in the content providing device 10 of the first embodiment, the determination processor 15 determines, by the above-described method, update order in which update objects included in web content displayed by the display devices 1 to 4 are updated, such that the out-of-sync of the display of the update objects is not noticeable. Then, the communicating unit 11 delivers the web content to each of the display devices 1 to 4. In addition, when there is a change in the update order, the communicating unit 11 delivers update order information to each of the display devices 1 to 4. By this, the out-of-sync of display timing between the display devices 1 to 4 can be resolved without placing a processing load for achieving display synchronization, on the display devices 1 to 4.

### Second Embodiment

Next, a second embodiment will be described. A content providing device 10 of the second embodiment differs from a content providing device 10 of the first embodiment in that interactive web content is delivered to each of display devices 1 to 4. In the description of the second embodiment, the case is described in which the positions of update objects included in web content are changed by an operation input by a user of the display devices 1 to 4. Note that, in the description of the second embodiment, different points from the first embodiment are described and a description of the same points as in the first embodiment is omitted.

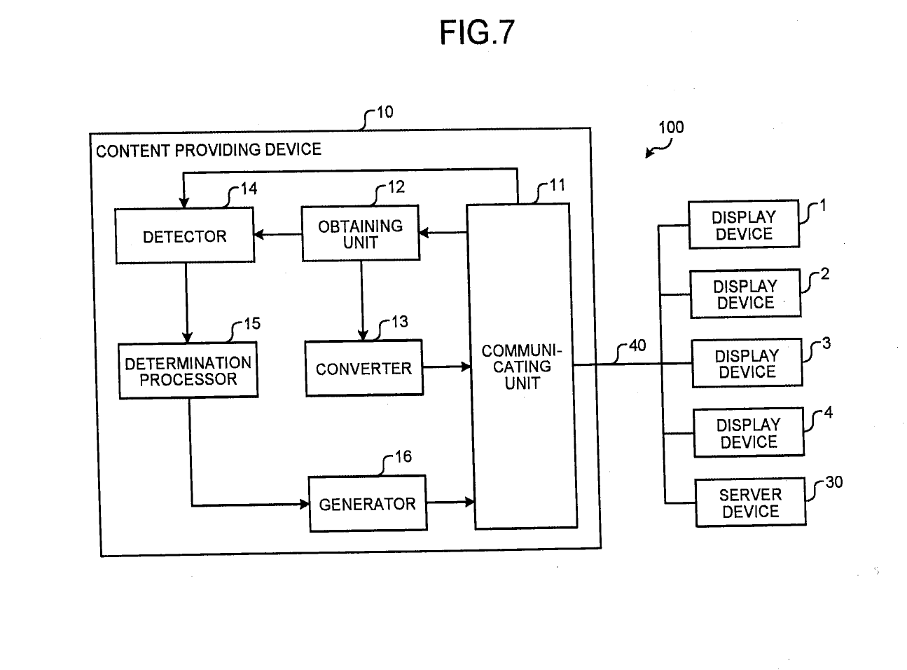

FIG. 7 is a diagram illustrating an example of a configuration of a content providing system 100 of the second embodiment. The overall configuration of devices in the content providing system 100 of the second embodiment is the same as that of a content providing system 100 of the first embodiment.

The content providing device 10 of the second embodiment includes a communicating unit 11, an obtaining unit 12, a converter 13, a detector 14, a determination processor 15, and a generator 16.

The communicating unit 11 receives, from the display devices 1 to 4, coordinate change information indicating the positions of update objects according to an operation input by a user of the display devices 1 to 4. The communicating unit 11 inputs the coordinate change information to the detector 14.

Now, an example of a user's operation input will be described.

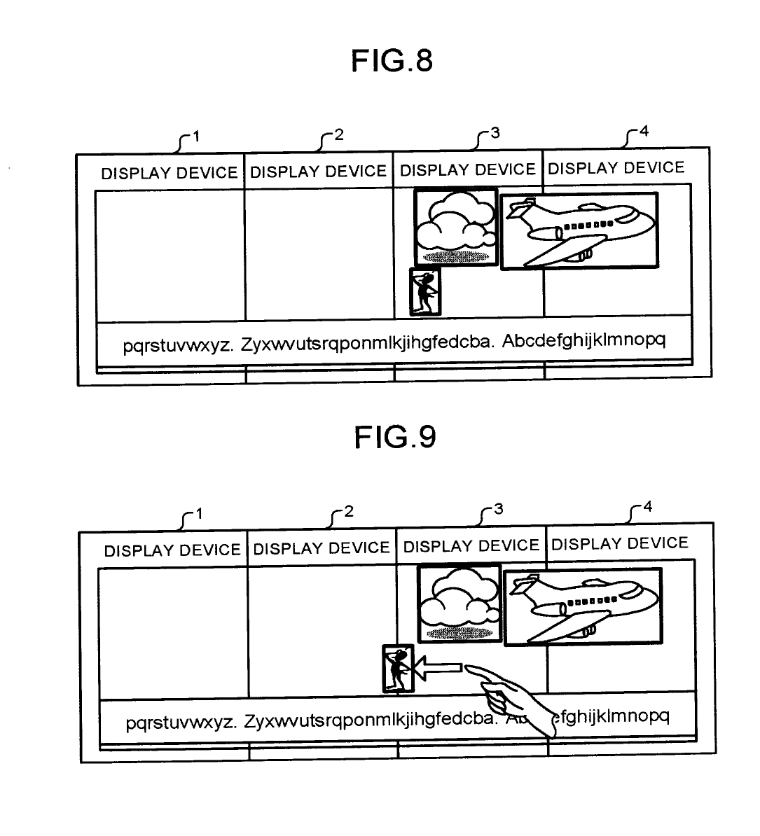

FIG. 8 is a diagram illustrating an example of web content displayed by the display devices 1 to 4 of the second embodiment. The positions, moving speeds, or moving directions of a cloud, an airplane, and a person included in the web content illustrated in FIG. 8 can be changed by an operation input such as a user's swipe operation on a screen.

The state of the display of the web content of FIG. 8 will be described. The display of a telop extends across the display devices 1 to 4. The display of the airplane extends across the display devices 3 and 4. The display of the cloud does not extend across a plurality of display devices, but moves from the right to the left. The display of the person does not extend across a plurality of display devices and does not move. Therefore, when the display of the web content is in the state of FIG. 8, the update order determined by the determination processor 15 of the content providing device 10 is the order of the telop, the airplane, the cloud, and the person.

FIG. 9 is a diagram illustrating an example of the case in which the web content of FIG. 8 has been updated. In the example of FIG. 9, the display position of the person has moved to a position extending across the display devices 2 and 3 by a user's swipe operation on the screen. By this, the update order of the update objects is changed between FIGS. 8 and 9.

Specifically, in the state of the display of the web content of FIG. 9, the display of the telop extends across the display devices 1 to 4. The display of the airplane extends across the display devices 3 and 4. The display of the cloud does not extend across a plurality of display devices, but moves from the right to the left. The display of the person extends across the display devices 2 and 3. Therefore, when the display of the web content is in the state of FIG. 9, the update order determined by the determination processor 15 is the order of the telop, the airplane, the person, and the cloud.

Referring back to FIG. 7, the display device 3 (or the display device 2) transmits, as coordinate change information, coordinates indicating the position of the person on the web content that is changed according to the user's operation input, to the content providing device 10.

When the communicating unit 11 receives the coordinate change information from the display device 3 (or the display device 2), the communicating unit 11 inputs the coordinate change information to the detector 14.

The detector 14 re-inputs information indicating update objects and information required to determine the update order of the update objects (history information described in the first embodiment, etc.) to the determination processor 15, based on the state of the web content currently displayed on the display devices 1 to 4 and the coordinate change information.

The determination processor 15 determines (changes) the update order of the telop, the airplane, the cloud, and the person to the update order (the order of the telop, the airplane, the person, and the cloud) described above in FIG. 9. The generator 16 generates update order information including information indicating update objects and the update order of the update objects, and delivers the update order information to each of the display devices 1 to 4 through the communicating unit 11.

When each of the display devices 1 to 4 includes, in its display region, an update object included in the update order information, the display device updates the update object according to the update order information and thereby updates the display of the web content.

As described above, in the content providing device 10 of the second embodiment, the communicating unit 11 receives the above-described coordinate change information from any one of the display devices 1 to 4. Then, the determination processor 15 further determines the update order of changed objects, based on the coordinate change information and thereby changes the update order of the update objects. By this, even if the web content is interactive, the out-of-sync of display timing between the display devices 1 to 4 can be resolved without placing a processing load for achieving display synchronization, on the display devices 1 to 4.

### Third Embodiment

Next, a third embodiment will be described. A content providing device 10 of the third embodiment differs from a content providing device 10 of the first embodiment in that instead of web content, image information is delivered as content to each of display devices 1 to 4. In the description of the third embodiment, the case is described in which image information rendered by the content providing device 10 is delivered to each of the display devices 1 to 4. Note that, in the description of the third embodiment, different points from the first embodiment are described and a description of the same points as in the first embodiment is omitted.

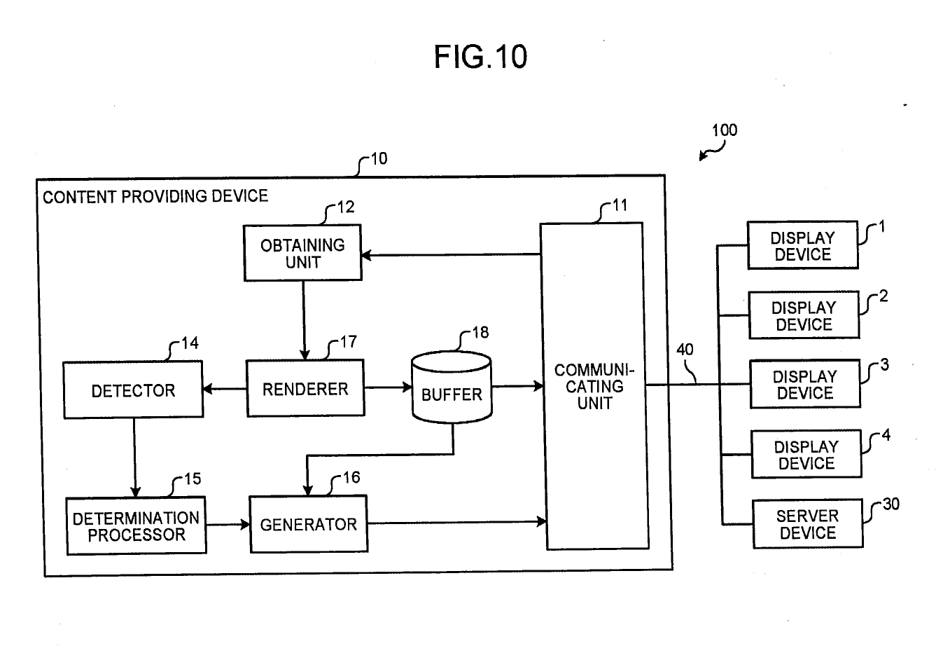

FIG. 10 is a diagram illustrating an example of a configuration of a content providing system 100 of the third embodiment. The overall configuration of devices in the content providing system 100 of the third embodiment is the same as that of a content providing system 100 of the first embodiment. Note, however, that a server device 30 stores content which is a source of generation of rendering information, instead of web content. The content is, for example, moving image files, document files, or presentation files.

The content providing device 10 of the third embodiment includes a communicating unit 11, an obtaining unit 12, a detector 14, a determination processor 15, a generator 16, a renderer 17, and a buffer 18.

The communicating unit 11 receives screen update request messages from each of the display devices 1 to 4. The communicating unit 11 inputs the screen update request messages to the obtaining unit 12. The screen update request message is information indicating a request for image information of content that changes according to the passage of time (image information of content for an image region displayed by each display device). Note that screen update request messages which are transmitted for the first time from each of the display devices 1 to 4 when the display devices 1 to 4 start display of image information of content include information specifying content which is a source of generation of rendering information. The information specifying content is the file name of the content, etc.

In addition, the communicating unit 11 delivers update image information generated by the generator 16 which will be described later, to each of the display devices 1 to 4.

The obtaining unit 12 receives the screen update request messages from the communicating unit 11. When the screen update request messages are those transmitted for the first time from the display devices 1 to 4, the obtaining unit 12 obtains content specified by the screen update request messages, from the server device 30. The obtaining unit 12 inputs the content to the renderer 17. When the screen update request messages are not those transmitted for the first time from the display devices 1 to 4, the obtaining unit 12 inputs a rendering request for image information of content that changes according to the passage of time on the display devices 1 to 4, to the renderer 17.

The renderer 17 accepts the content or the rendering request from the obtaining unit 12. When the renderer 17 accepts the content from the obtaining unit 12, the renderer 17 starts rendering of the content and generates image information to be displayed for the first time on each of the display devices 1 to 4. The renderer 17 stores the image information in the buffer 18.

When the renderer 17 accepts the rendering request from the obtaining unit 12, the renderer 17 renders image information of the content, according to a rendering instruction from an application or the like that executes the content, and thereby generates the image information of the content that changes according to the passage of time. The renderer 17 stores the image information in the buffer 18. In addition, the renderer 17 inputs region identification information required to identify update objects (update object image regions), to the detector 14. The region identification information is, for example, coordinate information included in the rendering instruction which is referred to when the renderer 17 renders the image information.

The buffer 18 stores the image information generated by the renderer 17. Note that even after the buffer 18 transmits the image information, the buffer 18 stores the image information as a backup without deleting the image information.

The detector 14 accepts the above-described region identification information from the renderer 17. The detector 14 identifies update regions from the region identification information and generates rectangular information including the update regions. The rectangular information indicates rectangular regions included in the image information of the entire content, and the positions of the rectangular regions. The detector 14 inputs the rectangular information to the determination processor 15. The rectangular information includes, for example, the coordinates of the starting point of a rectangle on the image information (buffer 18) indicating the entire content, a value (pixel) indicating the width from the starting point, and a value (pixel) indicating the height from the starting point. Note that the data format of the rectangular information inputted by the detector 14 to the determination processor 15 may be any. The detector 14 inputs to the determination processor 15, for example, rectangular information in a list format that includes a rectangular region with a width of 10 pixels and a height of 10 pixels from (0, 0) and a rectangular region with a width of 200 pixels and a height of five pixels from (30, 30).

The determination processor 15 accepts the rectangular information from the detector 14. The determination processor 15 determines, based on the rectangular information, update order in which update objects (update object image regions indicated by the rectangular information) are updated.

Specifically, the determination processor 15 determines, based on the positions of the rectangular regions indicated by the rectangular information, whether the update objects are displayed across a plurality of display devices. The determination processor 15 gives priority to the update order of an update object displayed across a plurality of display devices, over the update order of an update object not displayed across a plurality of display devices.

In addition, the determination processor 15 determines the frequency of update to the update objects by a history of rectangular information inputted from the detector 14. The determination processor 15 gives priority to the update order of an update object with a high frequency of update over the update order of an update object with a low frequency of update.

In addition, the determination processor 15 determines the areas of the update objects by the sizes of rectangles indicated by the rectangular information. The determination processor 15 gives priority to the update order of an update object with a large area over the update order of an update object with a small area.

In addition, the determination processor 15 determines the moving speeds of the update objects by the history of rectangular information inputted from the detector 14. The determination processor 15 gives priority to the update order of an update object with a high moving speed over the update order of an update object with a low moving speed.

Note that it may be determined as appropriate which one among the display positions of the update objects, the frequency of update to the update objects, the areas of the update objects, and the moving speeds of the update objects is given priority to determine the update order.

The determination processor 15 inputs the rectangular information indicating update objects and the update order of the update objects to the generator 16.

The generator 16 accepts the rectangular information indicating update objects and the update order of the update objects, from the determination processor 15. The generator 16 generates, from the rectangular information, update image information including partial image information and display position information of the partial image information. Specifically, the generator 16 generates the partial image information by reading, from the buffer 18, image information of regions where the display regions specified by the screen update request messages received from each display device intersect the rectangular regions indicated by the rectangular information. Then, the generator 16 delivers the update image information in turn according to the update order, through the communicating unit 11 to display devices that include, in their display regions, the partial image information included in the update image information.

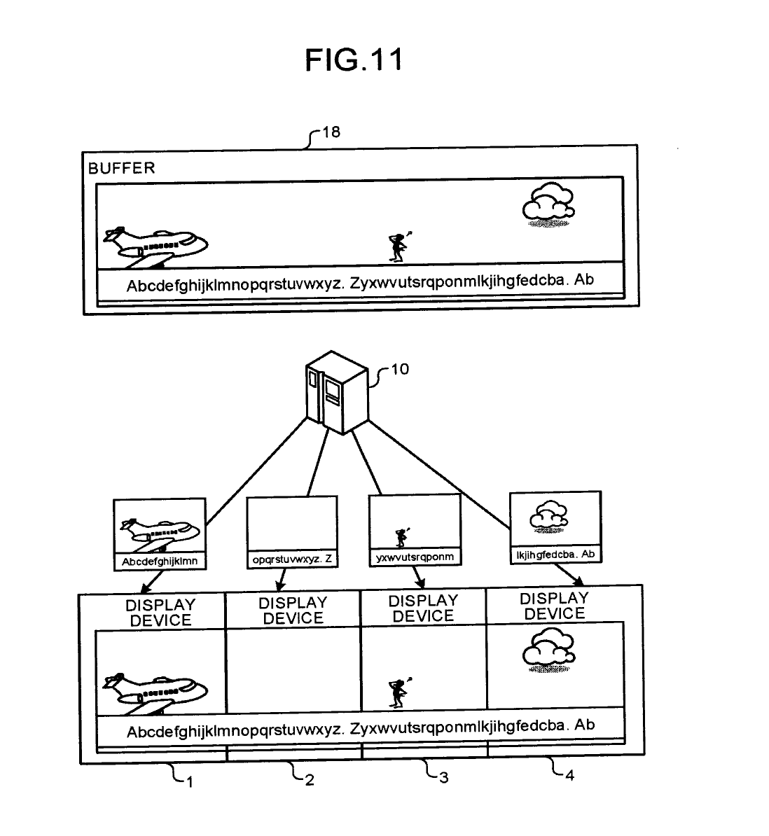

FIG. 11 is a diagram illustrating an example of image information which is delivered by the content providing device 10 of the third embodiment. When the display devices 1 to 4 start display of image information, image information which is rendered by the renderer 17 of the content providing device 10 and stored in the buffer 18 is delivered by the communicating unit 11 to the display devices 1 to 4. The example of FIG. 11 is an example of the case of delivering image information for one screen according to the display regions of the respective display devices. Note that the communicating unit 11 may deliver image information of the entire content and region specification information according to the display regions of the display devices, instead of image information for one screen according to the display regions.

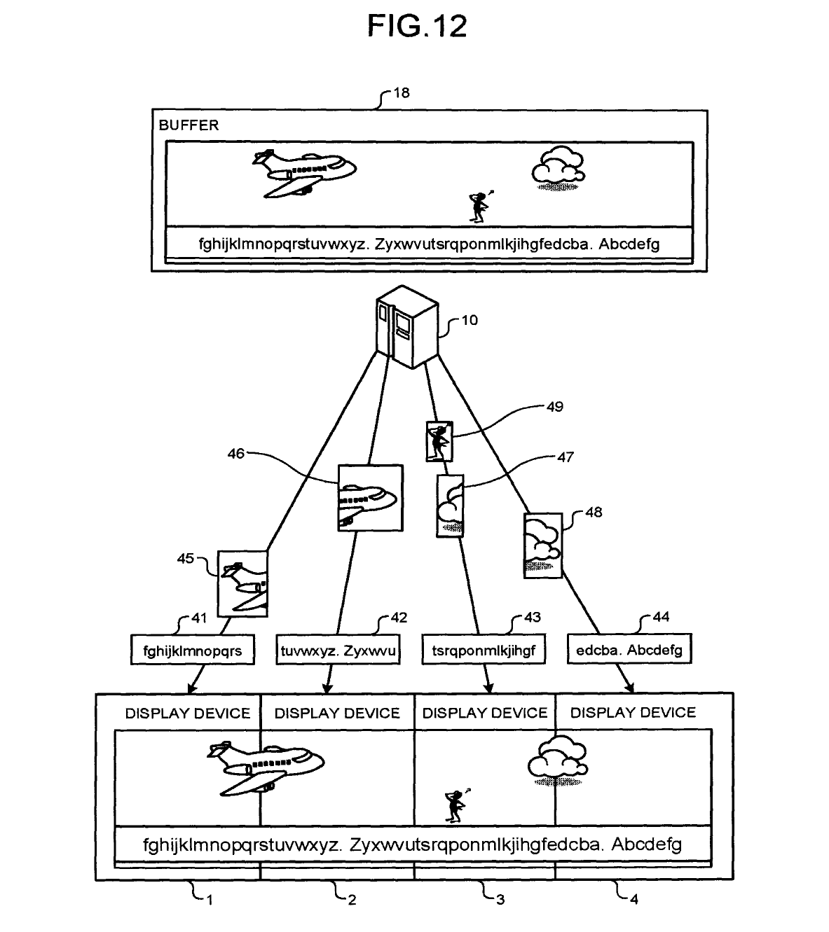

FIG. 12 is a diagram illustrating an example of update image information which is delivered by the content providing device 10 of the third embodiment. The content providing device 10 (communicating unit 11) delivers update image information to each of the display devices 1 to 4, according to update order determined by the determination processor 15.

Specifically, the content providing device 10 (communicating unit 11) delivers pieces of update image information 41 to 44 first that indicate a telop whose display extends across the display devices 1 to 4 and which has a high frequency of update and the largest area. Then, the content providing device 10 (communicating unit 11) delivers pieces of update image information 45 and 46 second that indicate an airplane whose display extends across the display devices 1 and 2 and which has a high frequency of update. Then, the content providing device 10 (communicating unit 11) delivers pieces of update image information 47 and 48 third that indicate a cloud whose display extends across the display devices 3 and 4 and which has a low frequency of update. Then, the content providing device 10 (communicating unit 11) delivers a piece of update image information 49 fourth that indicates a person not extending across a plurality of display devices.

Next, a content providing method for the content providing system 100 of the third embodiment will be described. First, an example of an operating method of the content providing device 10 will be described.

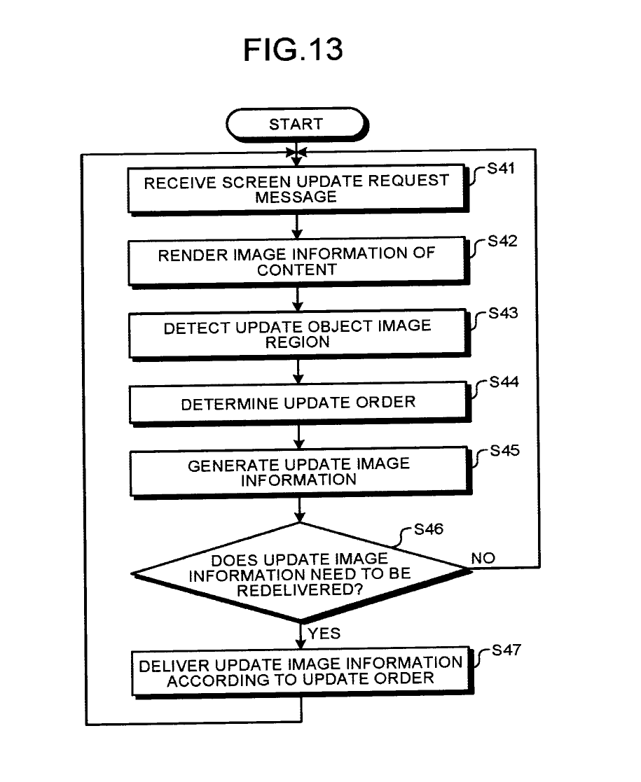

FIG. 13 is a flowchart illustrating an example of an operating method of the content providing device 10 of the third embodiment. First, the communicating unit 11 receives the above-described screen update request messages from the display devices 1 to 4 (step S41). Then, the renderer 17 renders image information of content according to a rendering instruction from an application or the like that executes the content, and thereby generates the image information of the content that changes according to the passage of time (step S42).

Then, the detector 14 detects update object image regions (update objects) of the image information (step S43). Specifically, the detector 14 identifies update regions from region identification information such as coordinate information included in the rendering instruction which is referred to by the renderer 17 upon rendering the image information. Then, the detector 14 generates rectangular information including the update regions and detects update object image regions (update objects) using the rectangular information.

Then, the determination processor 15 determines, based on the rectangular information, update order in which the update object image regions (update objects) are updated (step S44). Note that a specific method of determining update order is as described in FIGS. 10 and 12.

Then, the generator 16 generates, from the rectangular information, update image information including partial image information and the display positions of the partial image information (step S45). Specifically, the generator 16 generates the partial image information by reading, from the buffer 18, image information of regions where the display regions specified by the screen update request messages received from each display device intersect the rectangular regions indicated by the rectangular information. The partial image information is, for example, the pieces of partial image information 45 and 46 illustrated in FIG. 12.

Then, the detector 14 determines whether update image information needs to be redelivered due to the image information updated by the passage of time (step S46). If update image information needs to be redelivered (Yes at step S46), the update image information generated by the generator 16 at step S45 is delivered in turn according to the update order determined at step S44, through the communicating unit 11 to display devices that include, in their display regions, the partial image information included in the update image information (step S47). Then, the process of the content providing device 10 returns to step S41.

If there is no need to redeliver update image information (No at step S46), the process of the content providing device 10 returns to step S41.

Next, an example of an operating method of the display devices 1 to 4 will be described. Since the display devices 1 to 4 have the same operating method, the case of the display device 1 will be described as an example.

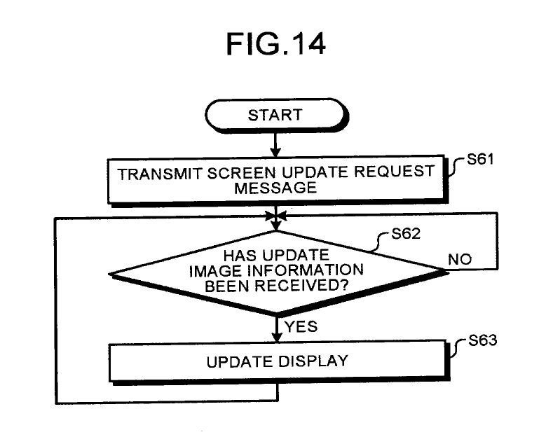

FIG. 14 is a flowchart illustrating an example of an operating method of the display device 1 of the third embodiment. The display device 1 transmits the above-described screen update request message to the content providing device 10 (step S61).

Then, the display device 1 determines whether update image information including partial image information and the display positions of the partial image information has been received from the content providing device 10 (step S62). If update image information has not been received (No at step S62), the display device 1 waits until receiving update image information. If update image information has been received (Yes at step S62), then, the display device 1 displays the partial image information included in the update image information at the positions specified by the display position information included in the update image information, and thereby updates the display of the content (image information) (step S63). Then, the process of the display device 1 returns to step S62.

As described above, in the content providing device 10 of the third embodiment, the renderer 17 renders image information. In addition, the generator 16 generates update image information including partial image information indicating update objects of the image information; and the display positions of the partial image information. Then, the communicating unit 11 delivers the update image information to each of the plurality of display devices 1 to 4 in update order determined by the determination processor 15. By this, even if the content is image information, the out-of-sync of display timing between the display devices 1 to 4 can be resolved without placing a processing load for achieving display synchronization, on the display devices 1 to 4.

Note that, in the above-described description, the case is described in which the content providing device 10 transmits update image information, according to screen update request messages. However, the content providing device 10 may receive screen update request messages from the display devices 1 to 4 only once when display of image information starts, and may not receive screen update request messages thereafter and may autonomously deliver update image information to each of the display devices 1 to 4.

### Fourth Embodiment

Next, a fourth embodiment will be described. A content providing device 10 of the fourth embodiment differs from a content providing device 10 of the first embodiment in that, when at least one of display devices 1 to 4 has low display performance, an update to some update objects (HTML elements) is not performed. In the description of the fourth embodiment, the case is described in which, when at least one of the display devices 1 to 4 has low display performance and thus an update to an update object by the display device cannot be performed in time, the content providing device 10 reduces the amount of web content. Note that, in the description of the fourth embodiment, different points from the first embodiment are described and a description of the same points as in the first embodiment is omitted.

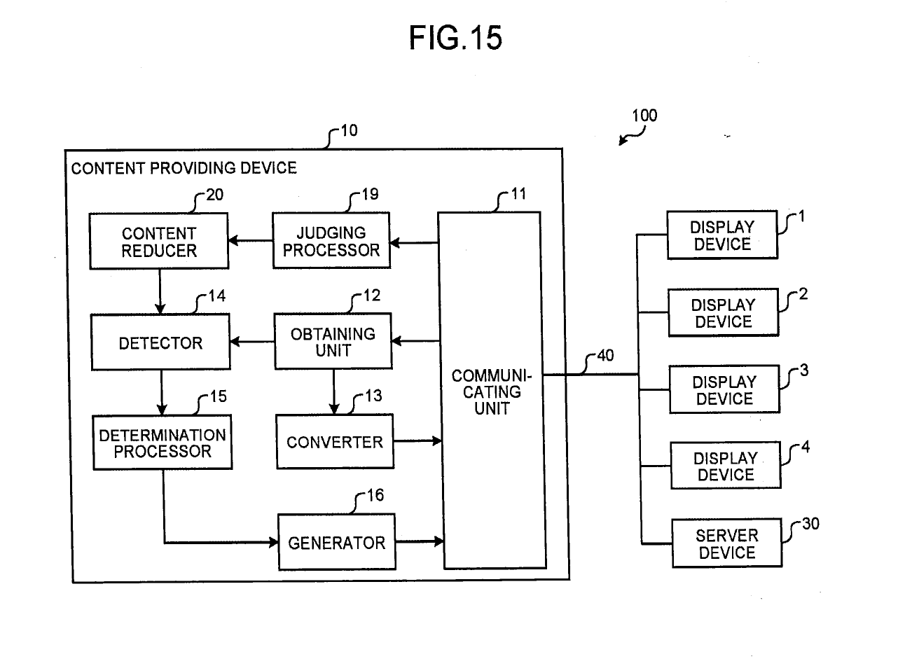

FIG. 15 is a diagram illustrating an example of a configuration of a content providing system 100 of the fourth embodiment. The overall configuration of devices in the content providing system 100 of the fourth embodiment is the same as that of a content providing system 100 of the first embodiment.

The content providing device 10 of the fourth embodiment includes a communicating unit 11, an obtaining unit 12, a converter 13, a detector 14, a determination processor 15, a generator 16, a judging processor 19, and a content reducer 20. The content providing device 10 of the fourth embodiment is such that the judging processor 19 and the content reducer 20 are further added to the configuration of the content providing device 10 of the first embodiment.

The judging processor 19 judges whether the display devices 1 to 4 can normally display web content (whether synchronization display by the display devices 1 to 4 can be performed). Note that a method of judging whether web content can be normally displayed may be any.

For example, the converter 13 described above in the description of the first embodiment may add to web content a JavaScript (registered trademark) program for transmitting an update complete message (corresponding to a complete notification) to the content providing device 10 when the display devices 1 to 4 have completed an update to the display of the web content. Then, the judging processor 19 may judge whether the display devices 1 to 4 can normally display web content, based on the transmission time of update order information and the reception time of a complete notification. Specifically, when, before the communicating unit 11 transmits the above-described update order information, the communicating unit 11 has not received an update complete message for an update to web content according to the immediately preceding update order information, the judging processor 19 may judge that the web content cannot be normally displayed.

In addition, for example, the communicating unit 11 may receive display performance information indicating display performance from the display devices 1 to 4. Namely, the judging processor 19 may judge, based on display performance information, whether the display devices 1 to 4 can normally display web content. Note that the display performance information may be any information. The display performance information is, for example, information such as the clock frequencies of CPUs of the display devices 1 to 4, whether there is a hardware decoder, or a browser name.

In addition, for example, the judging processor 19 may judge whether the display devices 1 to 4 can normally display web content, based on display load information indicating the load of a web content display process. Note that the display load information may be any. The display load information is, for example, measurement information obtained by measuring the load of a web content display process by performing the web content display process in advance on the content providing device 10.

When at least one of the display devices 1 to 4 cannot normally display web content (synchronization display by the display devices 1 to 4 cannot be performed), the judging processor 19 inputs a request to reduce the amount of the web content to the content reducer 20.

When the content reducer 20 accepts the request to reduce the amount from the judging processor 19, the content reducer 20 reduces the amount of the web content. The content reducer 20 reduces the amount of the web content by, for example, holding or deleting an update object (HTML element) which is not important, according to additional information indicating the importance of HTML elements included in the web content. Note that the content reducer 20 can hold an image by, for example, replacing animation with the <IMG> element. Alternatively, to reduce the frequency of update, the content reducer 20 may convert a variable in an animation program. The content reducer 20 may convert, for example, animation that is specified to move one pixel to the left every 15 milliseconds, to animation that moves two pixels to the left every 30 milliseconds. The content reducer 20 inputs the web content whose amount has been reduced to the detector 14.

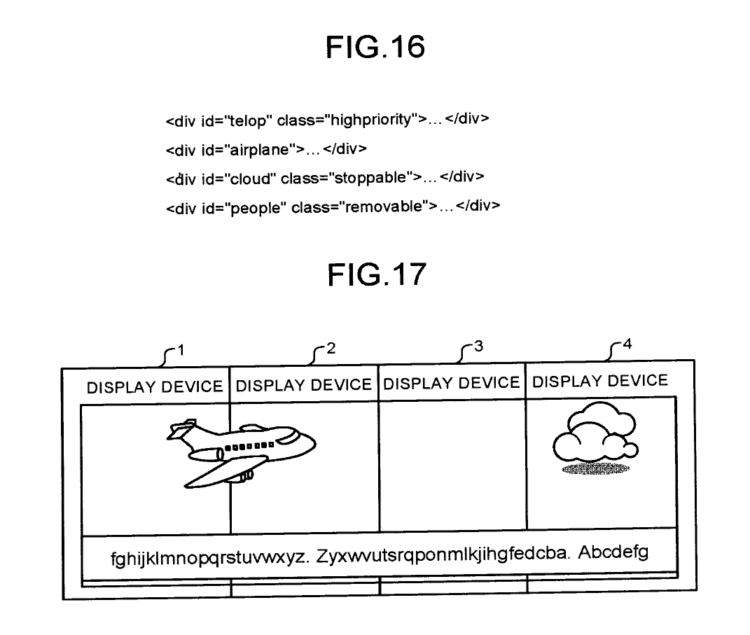

FIG. 16 is a diagram illustrating an example of additional information which is added to web content, of the fourth embodiment. The example of FIG. 16 is an example of the case in which web content includes additional information as the class names of HTML elements. An HTML element indicating a telop is specified with “highpriority” indicating that it is an important HTML element. In addition, an HTML element indicating a cloud is specified with “stoppable” indicating that it is an element that is able to be held. In addition, an HTML element indicating a person is specified with “removable” indicating that it is an element that is able to be deleted. Note that the additional information is, for example, provided in advance to web content when a web content developer develops the web content.

FIG. 17 is a diagram illustrating an example of web content whose amount has been reduced by the content reducer 20 of the fourth embodiment. The example of FIG. 17 illustrates the case in which, when the judging processor 19 has judged that at least one of the display devices 1 to 4 cannot normally display the web content of FIG. 16, the content reducer 20 has reduced the amount of the web content of FIG. 16. Specifically, the content reducer 20 stops the movement of the cloud specified with “stoppable”, and deletes the person specified with “removable”, and thereby reduces the amount of the web content of FIG. 16. Note that the above-described FIGS. 2 and 3 illustrate the display of web content before the amount of the web content is reduced by the content reducer 20.

Next, a content providing method for the content providing system 100 of the fourth embodiment will be described. First, an example of an operating method of the content providing device 10 will be described.

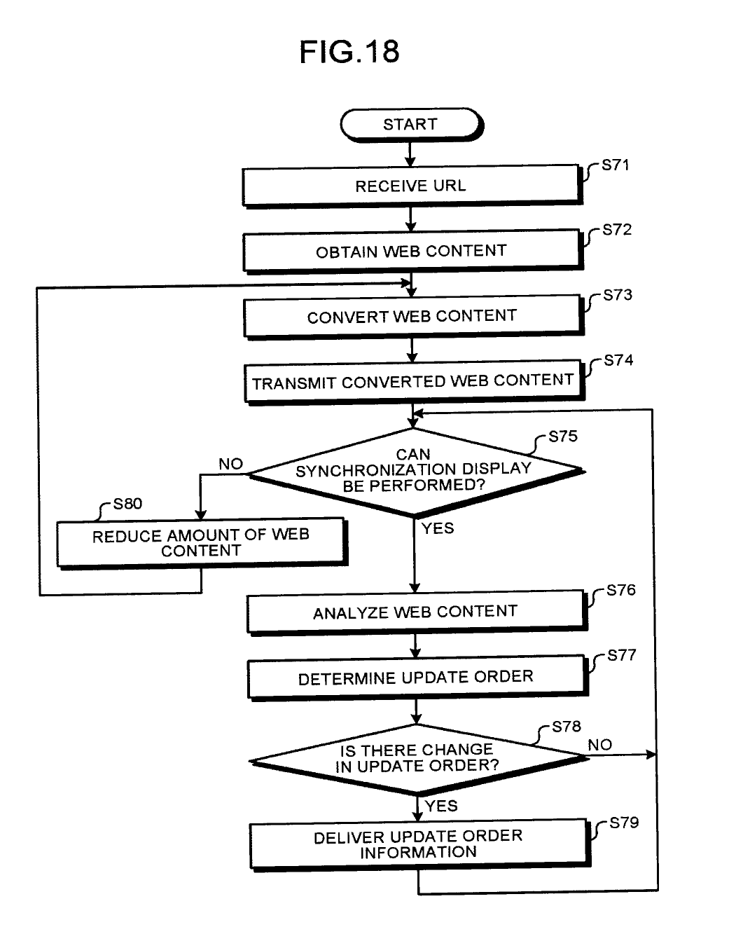

FIG. 18 is a flowchart illustrating an example of an operating method of the content providing device 10 of the fourth embodiment. A description of steps S71 and S72 is the same as that of steps S1 and S2 of the first embodiment and thus is omitted.

Then, the converter 13 converts the web content so that display of the content according to the display positions of the respective display devices 1 to 4, a change to the display of the web content according to the above-described update order information, and transmission of the above-described update complete message can be performed (step S73).

A description of step S74 is the same as that of step S4 of the first embodiment and thus is omitted.

Then, the judging processor 19 judges by the above-described method whether the display devices 1 to 4 can normally display the web content (whether synchronization display by the display devices 1 to 4 can be performed) (step S75). For example, when, before the communicating unit 11 transmits the above-described update order information, the communicating unit 11 has not received an update complete message for an update to web content according to the immediately preceding update order information, the judging processor 19 judges that the web content cannot be normally displayed.

If the web content can be normally displayed (Yes at step S75), the detector 14 analyzes the web content by the above-described method and thereby detects update objects which are dynamically updated, from the web content (step S76). Then, the determination processor 15 determines the update order of the update objects, based on at least one of conditions including coordinates indicating the display positions of the update objects, the frequency of update to the update objects, the areas of the update objects, and the moving speeds of the update objects (step S77). Then, the determination processor 15 determines whether there is a change in the update order (step S78). If there is a change in the update order (Yes at step S78), the generator 16 generates update order information including information indicating update objects and the update order of the update objects, and delivers the update order information to each of the display devices 1 to 4 through the communicating unit 11 (step S79). If there is no change in the update order (No at step S78), the process of the content providing device 10 returns to step S75.

If the web content cannot be normally displayed (No at step S75), the content reducer 20 reduces the amount of the web content by the above-described method (step S80) and returns to the process at step S73.

Next, an example of an operating method of the display devices 1 to 4 will be described. Since the display devices 1 to 4 have the same operating method, the case of the display device 1 will be described as an example.

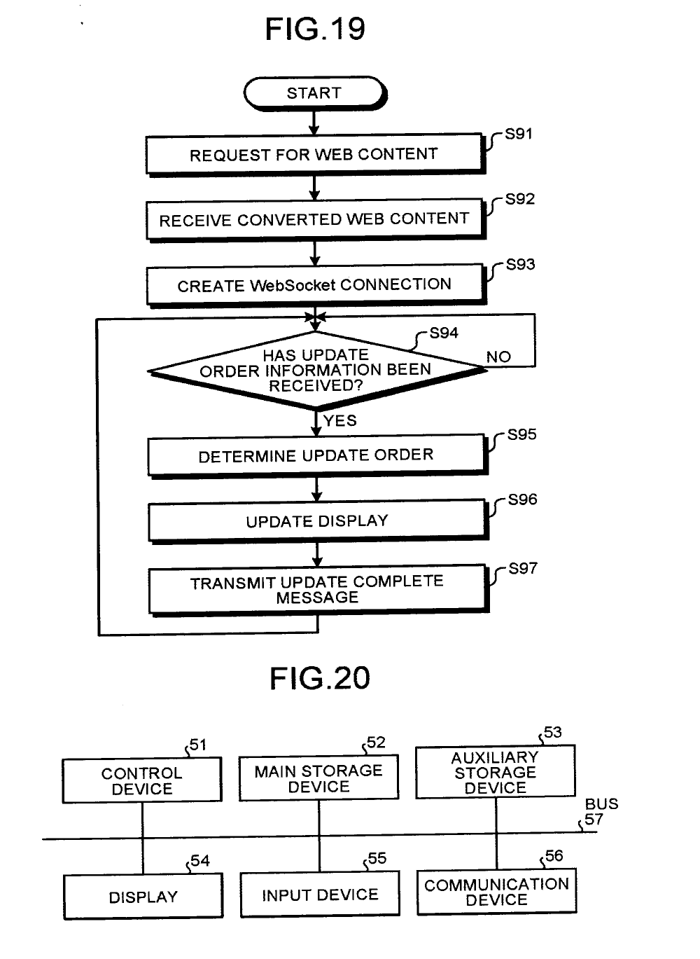

FIG. 19 is a flowchart illustrating an example of an operating method of the display device 1 of the fourth embodiment. A description of steps S91 to S96 is the same as that of steps S21 to S26 of the first embodiment and thus is omitted. After the display device 1 updates the display of the web content at step S96, the display device 1 transmits the above-described update complete message (step S97).

As described above, in the content providing device 10 of the fourth embodiment, the judging processor 19 judges whether the display devices 1 to 4 can normally display web content. Then, when web content cannot be normally displayed, the content reducer 20 reduces the amount of the web content by the above-described method so as to reduce the load of a web content display process. By this, even if at least one of the display devices 1 to 4 has low display performance, the out-of-sync of display timing between the display devices 1 to 4 can be resolved without placing a processing load for achieving display synchronization, on the display devices 1 to 4.

Finally, an example of a hardware configuration of the content providing devices 10 of the first to fourth embodiments will be described. FIG. 20 is a diagram illustrating an example of a hardware configuration of the content providing devices 10 of the first to fourth embodiments.

The content providing devices 10 of the first to fourth embodiments include a control device 51, a main storage device 52, an auxiliary storage device 53, a display 54, an input device 55, and a communication device 56. The control device 51, the main storage device 52, the auxiliary storage device 53, the display 54, the input device 55, and the communication device 56 are connected to each other through a bus 57.

The control device 51 executes a program which is read into the main storage device 52 from the auxiliary storage device 53. The main storage device 52 is a memory such as a ROM (Read Only Memory) or a RAM (Random Access Memory). The auxiliary storage device 53 is an HDD (Hard Disk Drive), an optical drive, or the like.

The display 54 displays, for example, the state of the content providing device 10. The display 54 is, for example, a liquid crystal display. The input device 55 is an interface for operating the content providing device 10. The input device 55 is, for example, a keyboard and a mouse. The communication device 56 is an interface for connecting to the network 40.

Programs executed by the content providing devices 10 of the first to fourth embodiments are recorded as files in an installable format or an executable format in a computer-readable storage medium such as a CD-ROM, a memory card, a CD-R, or a DVD (Digital Versatile Disk), and provided as computer program products.

In addition, the programs executed by the content providing devices 10 of the first to fourth embodiments may be configured to be provided such that the programs are stored in a computer connected to a network such as the Internet and downloaded via the network. Alternatively, the programs executed by the content providing devices 10 of the first to fourth embodiments may be configured to be provided via a network such as the Internet, without downloading the programs.

In addition, the programs of the content providing devices 10 of the first to fourth embodiments may be configured to be provided by pre-installing the programs in a computer program product a ROM, etc.

The programs executed by the content providing devices 10 of the first to fourth embodiments have a module configuration including the above-described functional blocks of FIG. 1, 7, 10, or 15. For the functional blocks as the actual hardware, by the control device 51 reading and executing a program from the above-described storage medium, the functional blocks are loaded into the main storage device 52. Namely, the above-described functional blocks are created on the main storage device 52. Note that some or all of the above-described functional blocks of FIG. 1, 7, 10, or 15 may be implemented by hardware such as an IC (Integrated Circuit), instead of being implemented by software.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A content providing device comprising:
a detector configured to detect update objects included in a content to be displayed across a plurality of display devices, the update objects being dynamically updated;
a determination processor configured to determine update order in which the update objects are updated;
a generator configured to generate update order information when there is a change in the update order, the update order information including the update order and information indicating the update objects; and
a communicating unit configured to deliver the content to the display devices, and deliver the update order information to the display devices when there is a change in the update order.

2. The content providing device according to claim 1, wherein the determination processor is configured to determine the update order of the update objects, based on at least one of conditions including whether each of the update objects is displayed across two or more of the display devices, frequency of update to the update objects, areas of the update objects, and moving speeds of the update objects.

3. The content providing device according to claim 1, wherein
the communicating unit is configured to receive, from each of the display devices, coordinate change information indicating coordinates of a corresponding update object changed according to a user's operation input, and
the determination processor is configured to further determine update order of the changed update object, based on the coordinate change information.

4. The content providing device according to claim 1, wherein
the content is web content,
the content providing device further comprises a converter configured to convert the web content so that the content is displayed at positions corresponding to the respective display devices and the display of the web content is updated according to the update order information, and
the communicating unit is configured to deliver the converted web content to each corresponding display device, and deliver the update order information to the display devices when there is a change in the update order.

5. The content providing device according to claim 4, further comprising:
a judging processor configured to judge whether the display devices can normally display the web content; and
a content reducer configured to reduce an amount of the web content so as to reduce a load of a process of displaying the web content, when at least one of the display devices cannot normally display the web content.

6. The content providing device according to claim 4, wherein
the converter is configured to further convert the web content so that a complete notification for an update to display of the web content according to the update order information is able to be transmitted,
the communicating unit is configured to receive the complete notification from each of the plurality of display devices when the update to the display of the web content has been completed, and
the judging processor is configured to judge whether the display devices can normally display the web content, based on transmission time of the update order information and reception time of the complete notification.

7. The content providing device according to claim 4, wherein
the communicating unit is configured to receive display performance information indicating display performance of each of the display devices, and
the judging processor is configured to judge, based on the display performance information, whether the display devices can normally display the web content.

8. The content providing device according to claim 4, wherein the judging processor is configured to judge, based on display load information, whether the display devices can normally display the web content, the display load information indicating a load of a process of displaying the web content.

9. The content providing device according to claim 5, wherein
the web content includes importance information indicating importance of HyperText Markup Language (HTML) elements, and
the content reducer is configured to reduce an amount of the web content by deleting the HTML elements among the HTML elements included in the web content, in ascending order of the importance.

10. The content providing device according to claim 1, wherein
the content is image information,
the content providing device further comprises a renderer configured to render the image information,
the generator is configured to generate update image information that includes partial image information indicating an update object of the image information and a display position of the partial image information, and
the communicating unit is configured to deliver the update image information in the update order to the display devices.

11. A content providing method comprising:
detecting update objects included in a content to be displayed across a plurality of display devices, the update objects being dynamically updated;
determining update order in which the update objects are updated;
generating update order information when there is a change in the update order, the update order information including the update order and information indicating the update objects;
delivering the content to the display devices; and
delivering the update order information to the display devices when there is a change in the update order.

12. A computer program product comprising a computer-readable medium containing a program executed by a computer, the program causing the computer to execute:
detecting update objects included in a content to be displayed across a plurality of display devices, the update objects being dynamically updated;
determining update order in which the update objects are updated;
generating update order information when there is a change in the update order, the update order information including the update order and information indicating the update objects;
delivering the content to the display devices; and
delivering the update order information to the display devices when there is a change in the update order.
